(19) United States
(12) Patent Application Publication
(10) Pub. No.: US 2015/0100875 A1
(43) Pub. Date: Apr. 9, 2015

(54) DISPLAY OF SPATIALLY-RELATED ANNOTATION FOR WRITTEN CONTENT

(71) Applicants: Seung Wook Kim, Cupertino, CA (US); Stefan Johannes Walter Marti, Oakland, CA (US); Davide Di Censo, Oakland, CA (US)

(72) Inventors: Seung Wook Kim, Cupertino, CA (US); Stefan Johannes Walter Marti, Oakland, CA (US); Davide Di Censo, Oakland, CA (US)

(73) Assignee: QUALCOMM Incorporated, San Diego, CA (US)

(21) Appl. No.: 14/381,880

(22) PCT Filed: Feb. 29, 2012
(86) PCT No.: PCT/US12/27089

§ 371 Date: Oct. 24, 2014

(51) Int. Cl. G06F 17/24

(52) U.S. Cl. CPC G06F 17/241
USPC 715/232

(57) ABSTRACT

Examples disclose a computing device comprising a processor to receive handwriting data from an electronic writing instrument describing written content provided on a surface off-screen from a display. Further, the examples provide the processor to analyze the handwriting data to determine an annotation corresponding to a portion of the written content. Additionally, the examples also disclose a display on the computing device to render the annotation at a position spatially related to a position of the portion of written content on the writing surface.

### BACKGROUND

In today's technology, users of computing devices typically rely on these devices to provide feedback to improve their writing capabilities and further understand their writing. The computing device may provide feedback, such as spelling and grammar errors on the display.

### BRIEF DESCRIPTION OF THE DRAWINGS

In the accompanying drawings, tike numerals refer to like components or blocks. The following detailed description references the drawings, wherein:

FIG. 1 is a block diagram of an example display on a computing device including an annotation rendered In a position spatially related to a position of a portion of written content on a writing surface;

FIG. 2 is a block diagram of an example computing device to receive handwriting data describing written content on a writing surface to analyze and render an annotation on a display;

FIG. 3 is a block diagram of an example computing device to display an annotation based on receiving handwriting data describing written content provided on a writing surface and including a storage area associated with a processor to determine the annotation based on an association of a keyword within the storage area;

FIG. 4 is a block diagram of a computing device to receive handwriting data describing written content provided on a writing surface and display an annotation in a position spatially related to a position of a portion of the written content on the writing surface, wherein the computing device receives the handwriting data using at least one of ultrasonic triangulation radio frequency triangulation, infra-red triangulation, and infra-red dots; and

FIG. 5 is a flowchart of an example method performed on a computing device to receive handwriting data provided on a writing surface, convert the handwriting to digital data to analyze and display an annotation.

### DETAILED DESCRIPTION

By providing feedback corresponding to a user's handwriting on a display of a computing device, a user may have an educational and informative experience. One solution is to provide feedback to the user utilizing a display wits a writing instrument that is dependent on a computing device, such as a stylus. The computing device receives writing from the user on the screen of the display and digitizes this on-screen mixing for display on the screen. However, this solution does not allow the user to handwrite off-screen from the display,

In another solution, an electronic writing instrument records a users handwriting off-screen and, in response, a computing device translates the handwriting to text and displays grammatical or spelling corrections with the translated text. In this solution, the user may not be able to view the feedback in relation to that portion of writing on the off-screen writing surface, further encouraging them to commit the same errors. Further, these solutions do not provide explicit assistant feedback that may be used to further understand words in a contextual use. For example, the feedback may include underlining a misspelled word, but may not let the user know the meaning of the word. This limits the type of knowledge the user gains in using these types of solutions.

To address these issues, example embodiments disclosed herein provide a computing device with a processor to receive handwriting data from an electronic writing instrument. The handwriting data is provided on a writing surface off-screen from a display of the computing device, enabling a user to write off-screen from the display. Allowing a user to provide handwriting data off-screen enables the computing device to track the location and movement of the electronic writing instrument, describing the written content provided on the writing surface. This further allows electronic instrument to be connected to the computing device wirelessly.

Additionally, the processor analyzes, the handwriting data to determine an annotation (i.e., feedback) corresponding to a portion of the written content (i.e., the user's writing). Further, the display on the computing devices renders the annotation in a position on the display spatially related to a position of the portion of written content on the writing surface. Providing the annotation spatially related to a position of the portion of written content on the writing surface, the user may immediately view feedback corresponding to the portion of written content This allows a user to view any errors in the handwriting to prevent future errors and also provides a useful context to the users handwriting. For example, the user may include in their handwriting an acronym to a word, as such, the computing device may display the annotation of the full definition of the word to aid the user in learning more about the word or verifying the correct use of the acronym. Additionally, by rendering feedback on the display to the user of the computing device, the computing device analyzes the hand written content and follows up with suggestions how to improve the context of the user's handwriting.

In another embodiment, the computing device may coordinate the annotations with a position on the witting surface by determining a size of the writing surface and translating the size to correspond to a size of the computing device. This enables the device to render the annotation on the display spatially related to the portion of written content despite the differing sizes between the display and the writing surface. For example, the display on the computing device may include a cell phone screen and as such, this may be much smaller in size than the writing surface.

In a further embodiment, the computing device renders the annotation without the handwriting data. In this embodiment, the computing device provides the annotation on the display without the written content provided on the writing surface. This embodiment provides a type of advising to the user for corrections and assistance with respect to their handwriting. Further, this also allows the user to focus directly on the feedback rather than becoming distracted with a full copy of the written content on the display.

Yet, in a further embodiment the annotation may include at least one of a trigger for performing a web search, a trigger for opening an application, a link, a definition of a word, and a correction of a word. In this embodiment, the annotation rendered on the display of the computing device operates as a personal assistant to aid the user in understanding and improving their writing. Additionally, the annotation may anticipate the user's needs. For example, the user may desire to know more about a word and as such, by providing a link, the device allows the user to skip the step of performing the word search themselves.

In summary, example embodiments disclosed herein provide a user with a more valuable educational and informative experience by rendering an annotation in a position spatially related to a position of the portion of written content on a writing surface. The annotation provides feedback in an explicit manner to the user to improve and understand their writing. Further, example embodiments allow the user to provide writing off-screen torn the display enabling the user to freehand their writing without the constraints of a continuous wired-connection.

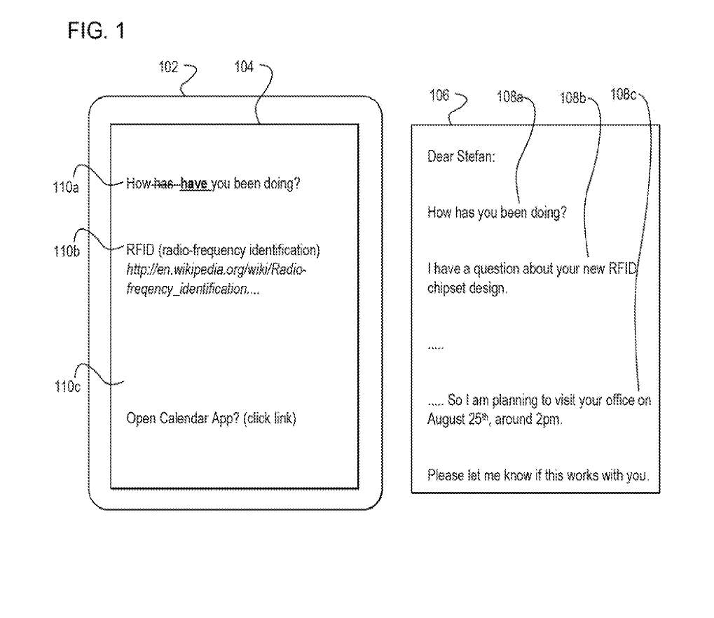

Referring now to the drawings, FIG. 1 is a block diagram of an example computing device 102 including display 104 rendering annotations 110a, 110b, and 110c in positions spatially related to positions of portions of written content 108a, 108b, and 108c provided on a writing surface 106. Embodiments of the computing device 102 include a client device, personal computer, desktop computer, laptop, a mobile device, a tablet, or other computing device suitable to include a display 104 to render the annotations 110a-110c.

The display 104 is a display associated with the computing device 102 to render the annotations 110a-110c. The display 104 includes the circuitry and screen for outputting content to the user, including the annotations 110a-110c. Embodiments of the display 104 include a computing screen, computing monitor, panel, plasma screen, liquid crystal display (LCD), thin film, projection, or other display technology capable of rendering annotations 110a-110c.

The annotations 110a-110c are considered feedback provided to a user and are rendered in positions on the display 120 spatially related to the positions of the portions of the written content 108a-108c on the writing surface 106. Although FIG. 1 depicts the display 104 as rendering annotations 110a-110c, embodiments should not be limited to this illustration as the display 104 may output any number of annotations. In one embodiment, the annotations 110a-110c may include at least one of: a trigger for performing a web search 110b, a trigger for opening an application 110c. a link 110c, a definition of a word 110b, and correction of a word 110a. in a further embodiment, the annotations 110a-110c are displayed without the handwriting data that describes the written content 108a-108c. For example, In this embodiment, the salutation at the top of the writing surface 108 is not included on the display 104, as there is no corresponding annotation. In this regard, the annotations 110a-110c are rendered without the handwriting data, thus enabling the user of the computing device 102 to focus on improving and understanding their writing. Additionally, the annotations 110a-110c correspond to each of the portions of the written content 108a-108c, respectively. For example, the annotation 110a near the top of the display 104 corresponds to the position of the portion of the written content 108a also near the top of the writing surface 106.

The writing surface 106 is the area of-screen from the display 104 of the computing device 102 where the user of the computing device 102 may handwrite the portions of written content 108a-108c. The writing surface 108 refers to the surface of which the user may utilize to inscribe written content 108a-108c with an electronic writing instrument. Thus, the writing surface may be, for example, a notebook, piece of paper, or another material on which the user physically writes. Alternatively, the writing surface 106 may be any planar surface suitable that enables a user to simulate writing, such as a surface of a table.

The portions of written content 108a-108c on the writing surface 108 are considered the user's writings provided on the writing surface 100. Specifically, the user may utilize an electronic writing instrument to create each of the portions of the written content 108a-108c. Additionally, handwriting data Is received by the computing device 102 mat describes the portions of the whiten content 108a-108c, This is explained in detail in later figures. The portions of the written content 108a-108c may include a single portion of written content such as 108a, combination or 108a-108c, or it may include additional portions of written content not illustrated in FIG. 1. The portions of the written content 108a-108c may be located within any area on the writing surface 208. For example, the portion of written content 108a may be located at the top right corner or the bottom left corner, etc.

The portions of the handwritten content 108a-108c correspond to and are spatially related to the position of each of the annotations 110a-110 as on the display 104. Spatially related refers to the display relationship between the position of each of the annotations 110a-110c on display 102 and the position of the corresponding portions of written content 108a-108c on writing surface 106. Specifically, the spatial relation specifies how to render the annotation 110a-110c on the display 104 in reference to the position of each of the portions of written content 108a-108c. For example, the portion of written content 108a asks how Stefan is doing and is written in a position near the top of the writing surface 108. As a result, the annotation 110a, correcting the grammar of the portion of written content 108a, is displayed in the position near the top of the display 104 and is therefore spatially related to the position of the portion of the written content 108a. In another example, the annotation 110b, explaining the word RFID and Including a link to this word definition, is near the middle of the display 104. The annotation 110b is therefore displayed in the position spatially related to the position of the portion of the written content 108b. Furthermore, the portion of written content 108c corresponding to the annotation 110c discusses a time for the user to visit an office in a position towards the bottom of the writing surface 108. The annotation 110c is spatially related to this portion of written content 108c by displaying the position of the annotation 110c towards the bottom of the display 104.

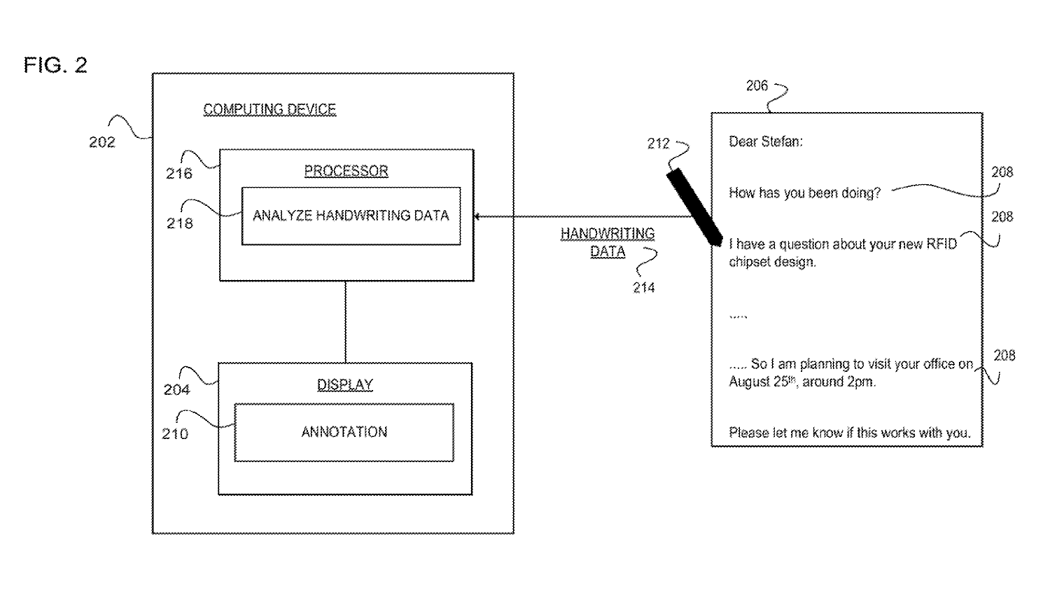

FIG. 2 is a block diagram of an example computing device 202 including a processor 216 and a display 204. The computing device 202 receives handwriting data 214 describing written content 208 from an electronic writing instrument 212 to analyze at module 218 to determine an annotation 210. The annotation 210 Is rendered on the display 204 in a position spatially related to a position of a portion of the written content 208 on the writing surface 208, The computing device 202 may be similar in structure and functionality to the computing device 102 of FIG. 1.

The writing surface 208 is a surface off-screen from the display 204 of the computing device 202 and is used for the electronic writing instrument 212 to create the written content 208. The writing surface 206 may be similar in structure and functionality to the writing surface 106 of FIG. 1.

The written content 208 is provided on the writing surface 206 with the electronic writing instrument 212. The written content 208 includes the portions of the written content provided by the user using writing instrument 212. The written content 208 is generated off-screen from the display 204 on the writing surface 206. As such, the user may utilize the electronic writing instrument 212 to make contact with the writing surface to create the written content 208. For example, as illustrated, the user may utilize the electronic writing instrument 212 to create a note addressed to Stefan.

The electronic writing instrument 212 is an electronic device utilized by the user to produce the written content 208 on the writing surface 206. Additionally, the electronic writing instrument 212 transmits the handwriting data 214 to the computing device 208 wirelessly or via a wired connection, such as a cable. The electronic writing instrument 212 may include circuitry and/or internal electronic components to transmit signals to the computing device 202 indicating a location and movement of the tip of the electronic writing instrument 212 on the writing surface 206. For example, the electronic writing instrument 212 may include a speaker to emit an ultrasonic signal detectable by computing device 202. In another example, the electronic writing instrument 212 may include a radio frequency (RF) emitter and/or infra-red (IR) emitter to transmit signals to the computing device 202. Embodiments of the electronic writing instrument 212 include a digital pen, a digital pencil stylus, electronic writing utensil, or other electronic writing instrument 212 capable of creating the written content 208 on the writing surface 206 and transmitting the handwriting data 214 to the computing device 202.

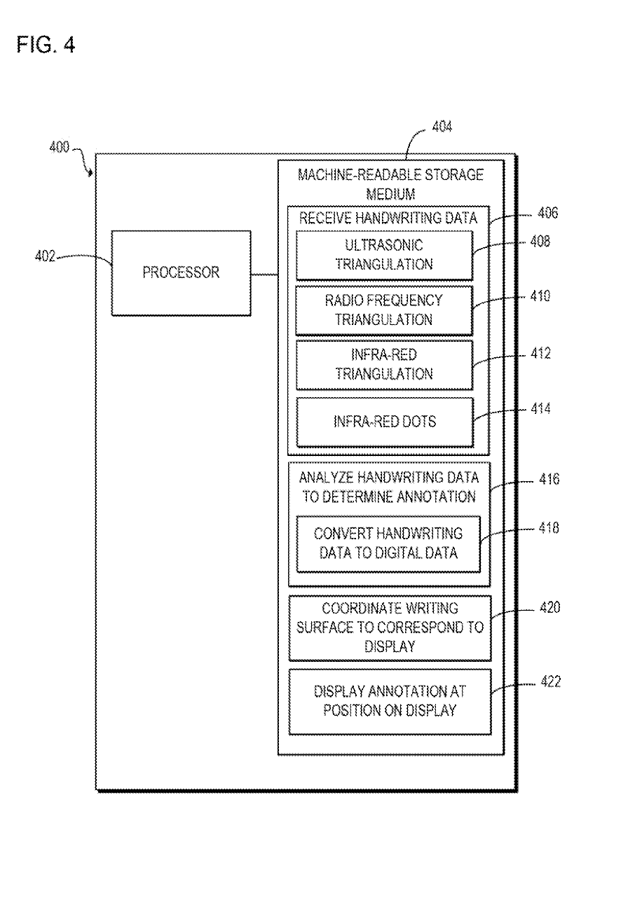

The handwriting data 214 describes the written content 208 provided on the writing surface 206 and is transmitted to the computing device 202 from the electronic writing instrument 212. Specifically, the handwriting data 214 may include coordinates of when the electronic writing instrument 212 tip is in contact with the writing surface 206. By receiving these coordinates which includes the location and the movement of the tip of the electronic writing instrument 212 in contact with the writing surface 206, the computing device 202 converts the coordinates into the written content 208 or digital text to analyze at module 218. The coordinates describe the written content 208 on the writing surface 206, which is off-screen from the display 204 of the computing device 202. In one embodiment, the electronic writing instrument 212 transmits the handwriting data 214 to the processor 218 which includes performing at least one of triangulation and/or trilateration. In this embodiment, the processor 216 determines the location of the electronic writing instrument 212 tip by measuring angles and/or distances between the location and previously known reference point. In another embodiment, the electronic writing instrument 212 transmits the handwriting data 214 to the processor 216 by performing at (east one of ultrasonic triangulation, radio frequency (RF) triangulation, infra-red (IR) triangulation, and infra-red (IR) dots. This embodiment is explained in greater detail in FIG. 4.

The processor 218 receives the handwriting data 214 from the electronic writing instrument 212 to analyze at module 218 to determine the annotation 210 to render on the display 204. In one embodiment, the processor 218 receives the coordinates of the handwriting data 214 and converts the coordinates to digital text to analyze at module 218. Embodiments of the processor 218 include a microchip, chipset, electronic circuit, microprocessor, semiconductor, microcontroller, central processing unit (CPU), graphics processing unit (GPU), visual processing unit (VPU), or other programmable device capable of receiving handwriting data 214 to analyze at module 218.

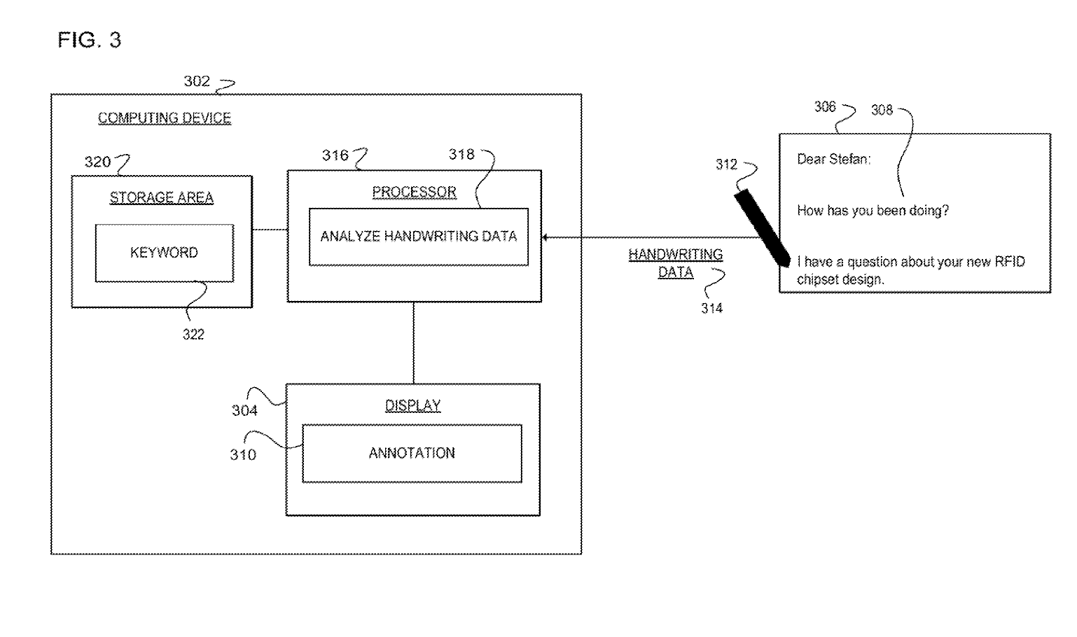

The module 218 analyzes the handwriting data 214 received from the electronic writing instrument 212 to determine the annotation 210. In one embodiment, module 218 includes converting the handwriting data 214 to digital data to analyze. In another embodiment of module 218, the handwriting data includes coordinates of the location and movement of the electronic writing instrument 212 on the writing surface 208. In this embodiment, module 218 includes converting these coordinates into text. Embodiments of the module 218 include a set of instructions executable by the processor 218 to analyze the handwriting data transmitted by the electronic writing instrument 212. In another embodiment, module 218, analyzes the context of the handwriting data to determine the annotation 210 relevant to that portion of the mitten content 208. In a further embodiment, module 218 determines the annotation by analyzing the handwriting data for a keyword. Then, once recognizing the keyword, the processor may obtain the annotation 210 from a storage area that associates the annotation 210 with the keyword. This embodiment is explained in detail in FIG. 3.

The annotation 210 is rendered on the display 204 in a position spatially related to the position of the portions of written content 208. For example, a portion of written content 208 may be positioned at the bottom right corner, thus the corresponding annotation 210 would be rendered in a position towards the bottom right corner on the display 204. In one embodiment, the display 204 on the computing device 202 renders the annotation 210 in real-time as the handwriting data 214 describing the written content 208 is provided on the writing surface 206. in this embodiment, the computing device 202 renders immediate feedback (i.e., annotations) while the user is generating the written content 208. The annotation 210 may be similar In structure and functionality to the annotations 110a-110c as in FIG. 1.

The display 204, included as one of the components of the computing device 202, renders the annotation 210 to the user of the computing device 202. The display 204 may be similar In functionality and structure to the display 104 as in FIG. 1.

FIG. 3 is a block diagram of an example computing device 302 including a processor 318 associated with a storage area 320 to identify an annotation 310 to render on a display 304 based on recognizing a keyword 322. Additionally, the processor 318 recognizes the keyword 322 by analyzing the handwriting data received from an electronic writing instrument 812 at module 318. Further, the electronic writing instrument 312 transmits the handwriting data 314 that describes written content 308 on a writing surface 306 off-screen from the display 304. The computing device 302 may be similar In structure and functionally to the computing device 102 and 202 In FIG. 1 and FIG. 2, respectively.

The writing surface 306 provides the written content 308 when the tip of the electronic writing instrument 312 is in contact with the writing surface 308. The electronic writing instrument 312 transmits the handwriting data 314 to the processor 318. The writing surface 308 and written content 308 may be similar in structure and functionally to the writing surface 108 and 208 and to the portions of written content 108a-108c and written content 208 as in FIG. 1 and FIG. 2, respectively. The electronic writing instrument 312 and the handwriting data 314 may be similar in structure and functionality to the electronic writing instrument 212 and to the handwriting data 214 as In FIG. 2.

The processor 316 receives the handwriting data 314 to analyze at module 318 to determine the annotation 310. The processor 318 may be similar in structure and functionality to the processor 216 as in FIG. 2. The module 318 may be similar In functionality to the module 218 as in FIG. 2.

The storage area 320 stores and/or maintains the keyword 322 associated with the annotation 310. More specifically, the processor 316 determines the annotation 310 based on an association of the text with a keyword 322 in the storage area 320. The processor 310 may communicate the keyword 322 with the storage area 320 on a network or residing on the computing device 302 to obtain the annotation 310. for example, the keyword “January” may signal for the processor 318 to analyze the context of the word. Thus, the processor 316 may obtain the annotation 310 which may include a trigger for opening a calendar application by looking for the keyword 322 “January” In the storage area 320. The storage area 320 may include several keywords associated with a single annotation 310. In keeping with the previous example, the word “Thursday” or “8 pm” indicate dates and as such, the processor 318 may look for these words in the storage area 320 to obtain the annotation 310 which may Include the trigger for opening the calendar application. Embodiments of the storage area 320 include a local storage, web storage, memory, memory buffer, cache, non-volatile memory, volatile memory, random access memory (RAM), an Electrically Erasable Programmable Read-Only memory (EEPROM), storage drive, a Compact Disc Read-Only Memory (CDROM), or other physical storage device capable of associating the keyword 322 with the annotation 310.

The keyword 322 Is associated with the annotation 310 within the storage area 320 for the processor 318 to obtain the annotation 310. In one embodiment the keyword 322 may include universal or global terms, for example, keywords related to a date, time, and/or schedule indicate an association with the annotation 310 to include a trigger for opening the calendar application. In another embodiment, the keyword 322 may be a term personalized to the user of the computing device 302. For example, the user may desire the keyword 322 to include a person's name and the annotation 310 would provide a link to that friend's social networking site.

The annotation 310 is obtained by the processor 310 and rendered in a position on the display 304 that is spatially related to the position of the portion of written content 308 on the writing surface 308. The annotation 310 may be similar in structure and functionality to the annotations 110a-110c and 210 as in FIG. 1 and FIG. 2, respectively.

The display 304 renders the annotation 310 to the user of the computing device 302. The display 304 may be similar in structure and functionality of the display 104 and 204 as in FIG. 1 and FIG. 2, respectively.

FIG. 4 is a block diagram of an example computing device 400 for receiving handwriting data and to perform at least one of ultrasonic triangulation, radio frequency (RF) triangulation, infra-red (IR) triangulation, and Infra-red (IR) dots. Further the computing device 400 analyzes the handwriting data to determine an annotation and renders the annotation on a display. Although the computing device 400 Includes processor 402 and machine-readable storage medium 404, it may also include other components that would be suitable to one skilled in the art. For example, the computing device 400 may include the storage area 320 as in FIG. 3. Additionally, the computing device 400 may be similar in structure and functionality of the computing devices 102, 202, and 302 as in FIGS. 1-3, respectively.

The processor 402 may fetch, decode, and execute instructions 408, 408, 410, 412, 414, 418, 418, 420, and 422. The processor 402 may be similar in functionality and structure to the processor 218 and 316 as in FIG. 1 and FIG, 2, respectively. Specifically, the processor 402 executes instructions 406 to receive handwriting data and further performs at least one of ultrasonic triangulation instructions 408, radio frequency (RF) triangulation instructions 410, infra-red (IR) triangulation instructions 412, and infra-red (IR) dots instructions 414. The processor 402 also executes analyze the handwriting data to determine an annotation instructions 418, convert the handwriting to digital data instructions 418, coordinate the writing surface to correspond to the computing device display instructions 420, and display the annotation on the display instructions 422.

The machine-readable storage medium 404 may include instructions 400, 408, 410, 412, 414, 416, 418, 420, and 422 for the processor 402 to fetch, decode, and execute. The machine-readable storage medium 404 may be an electronic, magnetic, optical, memory, storage, flash-drive, or other physical device that contains or stores executable instructions. Thus, the machine-readable storage medium 404 may include, for example, Random Access Memory (RAM), an Electrically Erasable Programmable Read-Only Memory (EEPROM), a storage drive, a memory cache, network storage, a Compact Disc Read Only Memory (CDROM) and the like. As such, the machine-readable storage medium 404 may include an application and/or firmware which can be utilized independently and/or in conjunction with the processor 402 to fetch, decode, and/or execute instructions of the machine-readable storage medium 404. The application and/or firmware may be stored on the machine-readable storage medium 404 and/or stored on another location of the computing device 400.

Instructions 408 include the computing device 400 receiving handwriting data from the electronic writing instrument. The handwriting data includes coordinates to Indicate the location and movement of the tip of the electronic writing instrument 212 while in contact with the writing surface. This allows the handwriting data to describe the written content provided on the writing surface. In one embodiment, instructions 406, further includes performing at least one of triangulation and/or trilateration to determine the movement and location of the tip of the electronic writing instrument. In another embodiment, instructions 406, further includes instructions to perform at least one of instructions 408-414. For example, the computing device receives the handwriting data and may perform radio frequency (RF) triangulation instructions 410.

Instructions 408 include performing ultrasonic triangulation. In this embodiment of Instructions 408, the electronic writing instrument includes a speaker that emits an ultrasonic signal. The computing device 400 may include receivers, such as a microphone, to receive the emitted ultrasonic signal. Additionally, the computing device 400 may determine differences in timing and/or strength of the emitted ultrasonic signal to determine the location and movement of the electronic writing instrument within a determined area (i.e., the writing surface). Alternatively, the speaker is on the computing device 400, and the receivers are on the electronic writing instrument.

Instructions 410 include performing radio frequency (RP) triangulation. In this embodiment of instructions 410, the electronic writing instrument includes a radio frequency (RF) emitter to transmit a radio frequency (RF) signal to the computing device. The computing device 400 includes receivers to receive the RF signal and may determine differences in timing, frequency, and/or strength to indicate the location and movement of the electronic writing instrument within the writing surface. Alternatively, the emitter is on the computing device 400, and the receivers are on the electronic writing instrument.

Instructions 412 include performing Infra-red (IR) triangulation. In this embodiment of instructions 412, the electronic writing instrument includes an infra-red emitter that emits an infra-red (IR) signal and the computing device 400 includes a infrared (IR) detectors to receive the IR signal. Additionally, in this embodiment, the computing device 400 may determine differences with the timing, frequency, and/or strength of the IR signal to further determine the movement and location of the electronic writing instrument within the writing surface. Alternatively, the emitter is on the computing device 400, and the defectors are on the electronic writing instrument.

Instructions 414 include performing infra-red (IR) dots. In this embodiment of instructions 414, the electronic writing instrument includes a camera that detects IR dots on the writing surface. Further in this embodiment, the IR dots may create a pattern and this pattern is used for the electronic writing instrument to determine its position relative to the computing device 400.

Instructions 418 include analyzing the handwriting data received at instructions 406 to determine the annotation. In one embodiment instructions 416 include analyzing the handwriting data and further includes instructions 418 to convert the handwriting data to digital data. In this embodiment, the handwriting data may include coordinates and as such, these coordinates are converted to digital data for analysis.

Instructions 418 include converting the handwriting data to digital data. In one embodiment of instructions 418, the handwriting data describing written content received from the electronic writing instrument, includes coordinates that are converted into text and the text is analyzed by the computing device 400 to determine the annotation.

Instructions 420 include coordinating the writing surface to correspond to the display associated with the computing device 400. Additionally, instructions 420 include the computing device 400 translating the size of the writing surface to correspond to the size of the display on the computing device 400. This embodiment enables the situations in which the writing surface and the display of the computing device 400 are differing sizes so the annotation is displayed in position spatially related to the position of the portion of written content, regardless of the differing sizes. In one embodiment, instructions 420 may occur prior or simultaneously to instructions 406. In another embodiment, instructions 420 may occur simultaneously with instructions 418 and 420.

Instructions 422 include displaying the annotation determined at instructions 410 on the display of the computing device 400. Specifically, the annotation is displayed in a position spatially related to the position of the portion of the written content.

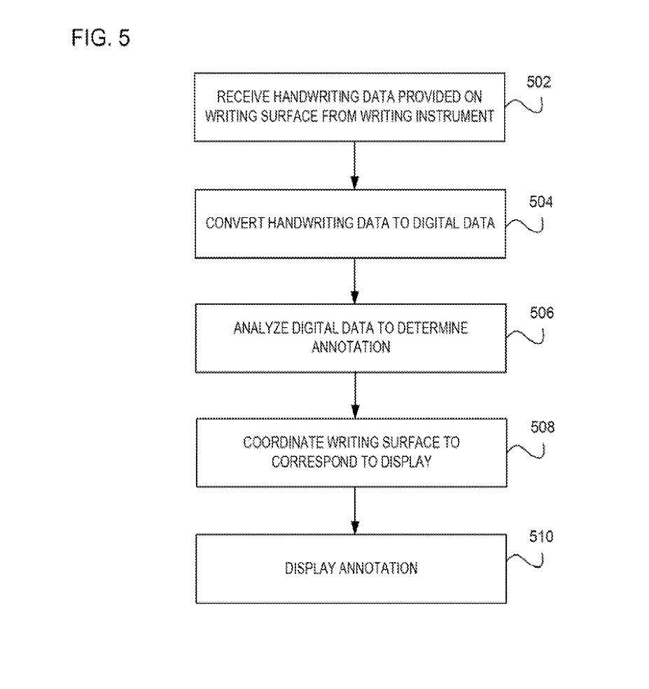

FIG. 5 is a flowchart of an example method performed on a computing device to receive handwriting data, convert the handwriting data to digital data, and analyze the handwriting data to determine an annotation to display. Although FIG. 5 is described as being performed on computing device 102, 202, 302, and 400 as in FIGS 1-4, it may also be executed on other suitable components as will be apparent to those skilled in the art. For example, FIG. 5 may be implemented in the form of executable instructions on a machine-readable storage medium, such as machine-readable storage medium 404 in FIG. 4.

At operation 502, the computing device receives handwriting data describing written content provided on a writing surface from an electronic writing instrument. In one embodiment of operation 502, the computing device receives the handwriting data which includes coordinates indicating the movement and location of the electronic writing instrument when in contact with the writing surface. The coordinates describe the written content on the writing surface, which is off-screen from the display of the computing device. In another embodiment of operation 502, the electronic writing instrument transmits the handwriting data including text describing the written content.

At operation 504, the computing device converts the handwriting data received at operation 502 to digital data. In one embodiment, the handwriting data Includes the coordinates and as such, the computing device converts the coordinates to digital data, such as digital text, describing the written content. In another embodiment, the computing device receives text describing the written content and as such converts the text into digital data.

At operation 506, the computing device analyzes the digital data generated at operation 504 to determine an annotation that corresponds to a portion of the written content provided on the writing surface. In one embodiment of operation 506, the computing device analyzes the digital data to recognize a keyword. In this embodiment, the computing device may communicate with a focal storage area or network storage area to determine the annotation based on the association of the keyword within the storage area.

At operation 508, the computing device coordinates the writing surface to correspond to the display on the computing device. Specifically, at operation 508, the computing device translates the size of the display on the computing device to correspond to a size of the writing surface. In one embodiment, operation 508 occurs prior to receiving the handwriting data at operation 502. In another embodiment, operation 508 occurs prior to displaying the annotation at operation 510. In a further embodiment, operation 508 may occur simultaneously with operations 502, 504, 506, and 510.

At operation 510, the computing device displays the annotation that was determined at operation 508. Additionally, at operation 510, the annotation is rendered on the display in a position that is spatially related to a position of the portion of written content on the writing surface.

The embodiments described in detail herein provide a user with a more educational and informative experience by rendering an annotation in a position spatially related to a position of the portion of written content on a writing surface. The annotation provides feedback in an explicit manner to the user to improve and understand their writing.

1-15. (canceled)

16. A method executed by a computing device for providing feedback to a user, the method comprising:
receiving handwriting data describing written content provided on a writing surface from an electronic writing instrument, the writing surface off screen from a display of the computing device;
analyzing the handwriting data to determine an annotation corresponding to a portion of the written content; and
displaying the annotation at a position of the display of the computing device, wherein the position of the annotation is spatially related to a position of the portion of the written content on the writing surface.

17. The method of claim 16 wherein to receive the handwriting data describing written content provided on the writing surface further comprising to perform triangulation.

18. The method of claim 16 wherein the annotation includes a trigger for opening an application.

19. The method of claim 16, wherein analyzing the handwritten data further comprises:
converting the handwriting data to a digital data, and analyzing the digital data to determine the annotation.

20. The method of claim 16, further comprising:
coordinating the writing surface to correspond to the display of the computing device by determining a size of the writing surface and translating the size to correspond to a size of the display of the computing device.

21. The method of claim 16, wherein the display of the computing device displays the annotation without the handwriting data.

22. The method of claim 16, wherein the annotation includes a correction of a grammatical error.

23. The method of claim 16, wherein the annotation includes a suggestion to aid understanding of the handwritten content.

24. A computing system for providing feedback to a user, comprising:
a computing device comprising
a display; and
a processor to:
receive handwriting data describing written content provided on a writing surface from an electronic writing instrument, the writing surface off screen from the display of the computing device; and
analyze the handwriting data to determine an annotation corresponding to a portion of the written content; and
to render the annotation at a position of the display, the position of the annotation spatially related to a position of the portion of written content on the writing surface.

25. The computing system of claim 24 further comprising:
an electronic writing instrument associated with the computing device to transmit the handwriting data.

26. The computing system of claim 24 wherein:
to analyze the handwriting data to determine the annotation, the processor is to recognize a keyword within the handwriting data, and
the computing device further comprises a storage area associated with the processor wherein the processor determines the annotation based on an association of the keyword in the storage area.

27. The computing system of claim 24 wherein the computing device renders the annotation in real-time as the handwriting data describing written content is provided on the writing surface.

28. The computing system of claim 24 wherein the display of the computing device renders the annotation without the handwriting data.

29. The computing system of claim 24 wherein to receive the handwriting data describing written content provided on the writing surface from the electronic writing instrument further comprising instructions to perform triangulation.

30. A non-transitory machine-readable storage medium encoded with instructions executable by a processor of a computing device for providing feedback to a user, the storage medium comprising instructions to:
receive handwriting data describing written content provided on a writing surface from an electronic writing instrument, the writing surface off screen from a display of the computing device;
analyze the handwriting data to determine an annotation corresponding to a portion of the written content; and
display the annotation at a position of the display of the computing device, wherein the position of the annotation is spatially related to a position of the portion of the written content on the writing surface.

31. The non-transitory machine-readable storage medium including the instructions of claim 30, further comprising instructions to:
coordinate the writing surface to correspond to the display of the computing device by determining a size of the writing surface and translating the size to correspond to a size of the display of the computing device.

32. The non-transitory machine-readable storage medium of claim 30, wherein the instructions to analyze further comprise instructions to convert the handwriting data to a digital data.

33. The non-transitory machine-readable storage medium of claim 30, wherein the instructions to receive the handwriting data further comprise instructions to perform triangulation.

34. The non-transitory machine-readable storage medium of claim 30, wherein the annotation includes a correction of a word.

35. The non-transitory machine-readable storage medium of claim 30, wherein the display of the computing device displays the annotation without the handwriting data.
